(19) United States
(12) Patent Application Publication
(10) Pub. No.: US 2008/0260928 A1
(43) Pub. Date: Oct. 23, 2008

(54) Flexible Pad for Preparing a Beverage

(76) Inventors: John MacMahon, Brackley (GB); Adam Fennel, Charlotte, NC (US); Satwinder Panesar, Banbury (GB); Lee Rowan, Bedworth (GB); Audrey Trouillot, Bremen (DE); Bary Zeller, Glenview, IL (US); Heather Hudson, San Diego, CA (US); Anilkumar Gaonkar, Buffalo Grove, IL (US)

Correspondence Address: FITCH EVEN TABIN & FLANNERY, 120 S. LASALLE STREET, SUITE 1600, CHICAGO, IL, 60603-3406, US

(21) Appl. No.: 11/577,525

(22) PCT Filed: Oct. 24, 2005
(86) PCT No.: PCT/GB05/04104

§ 371 Date: May 12, 2008

(30) Foreign Application Priority Data
Oct. 22, 2004 (GB) 0423531.3

(51) Int. Cl. A23C 9/18; B65D 85/804; B65D 81/00; A23C 9/15; A47J 31/40

(52) U.S. Cl. 426/588; 99/295; 426/77; 426/506

(57) ABSTRACT

A flexible pad for preparing a beverage comprising: a filter bag defining a storage volume; the storage volume containing a water-soluble composition or a combination or mixture of water-soluble compositions for forming a beverage; wherein the storage volume further contains a plurality of non-soluble absorbent particles having a particle size, before use, of 25 microns to 10 mm.

This application is a U.S. national phase application filed under 35 U.S.C. §371 of International application PCT/GB2005/004104, filed on Oct. 24, 2005, designating the United States, which claims the benefit of Great Britain patent application No. 0423531.3, filed on Oct. 22, 2004, which is hereby incorporated by reference herein.

The present invention relates to improvements in pads for preparing beverages which contain a water soluble substance. The water soluble substance may be a powdered ingredient for making a beverage such as coffee, tea or soup, fruit juice and desserts. The invention finds particular advantage where the water soluble substance is a milk powder or creamer powder. The pads are also known as pods, cartridges, capsules, pouches and bags.

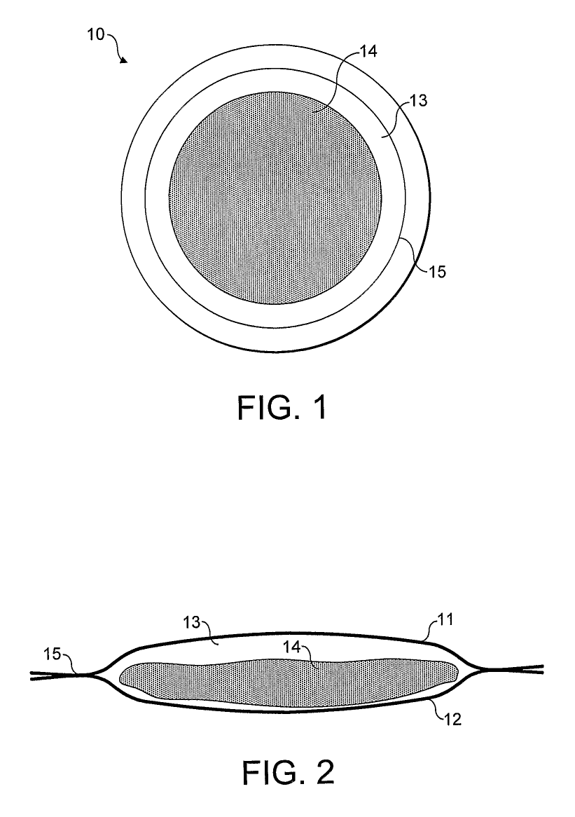

An example of a known pad is shown in FIGS. 1 and 2. The pad 10 is simple in construction and comprises a circular upper sheet 11 and a circular lower sheet 12 of filter material which are bonded together around a peripheral seam 15 to define and seal a storage volume 13 in which the water soluble substance 14 is contained. In use, the pad 10 is placed in a beverage preparation machine such as a coffee brewer and heated water is passed through the pad 10. The heated water flows through the upper sheet 11 and lower sheet 12 of filter material and in so doing contacts and dissolves the water soluble substance 14 contained in the storage volume 13 to form the beverage. The beverage then passes through the lower sheet 12 of the filter material and is dispensed into a suitable receptacle. The water soluble substance may be used to form the whole or part of a beverage. Where the water soluble substance is a milk powder or creamer powder, the pad may be used to form a milk- or creamer-based beverage or to form a milk- or creamer-based portion of an alternative beverage such as coffee.

Pads with creamer powders or milk based products may be used in dispensing cappuccino-style beverages. Such pads may be used in the beverage preparation machine on their own to dispense a milky, creamy or frothy beverage portion onto an already dispensed beverage, such as coffee. Alternatively, the pad containing the creamer powder or milk-based substance may be used in the beverage preparation machine in combination with a pad containing a substance for producing another beverage portion. For example, two pads may be used at the same time in the machine, one pad containing a creamer powder and one pad containing roast and ground coffee as taught in EP0756844. In this way, a complete beverage may be dispensed in one operation cycle of the beverage preparation machine.

The pads described above are similar to well known tea bags which are used for infusing hot water with tea leaves. However, there are a number of particular problems in using such flexible pads in beverage preparation machines where the pads contain a water soluble product such as a milk powder or creamer powder as opposed to a product which is infused in water but is not itself dissolved, such as roast and ground coffee or tea leaves. One disadvantage is that as the water soluble substance 14 is dissolved by the water passing through the pad, the pad tends to collapse in on itself bringing the upper sheet 11 and lower sheet 12 of filter material into contact with one another. In addition, because the dissolution of the water soluble substance 14 is not necessarily uniform throughout the storage volume of the pad 10 during use this can lead to portions of the filter material collapsing before the whole or a substantially part of the water soluble substance 14 has been dissolved. Where the upper sheet 11 and the lower sheet 12 of filter material contact one another, there is formed a low resistance flow path for the heated water. As a result, as soon as the pad 10 starts to collapse, the heated water has a tendency to flow through the portions of the pad 10 where the upper sheet 11 and lower sheet 12 are in contact rather than flowing more uniformly through the entire storage volume of the pad 10. This problem is exacerbated where the pad is used in a beverage preparation machine together with another pad containing another beverage portion as described above. It is preferred in such one-step dispensing of a beverage that the pad containing the infusible substance such as roast and ground coffee is placed on top of the pad containing the water soluble product so as to ensure proper extraction of the infusible substance as taught in EP0756844. However, the additional weight of the pad containing the infusible substance increases the likelihood that the pad containing the water soluble substance will collapse during the dispense cycle. For these reasons, use of pads such as those shown in FIGS. 1 and 2 can lead to substantial portions of the water soluble substance 14 being left within the pad 10 after the beverage preparation machine has completed its dispense cycle. Experiments show that for commonly used creamer powders as much as 40 to 60% of the creamer powder remains in the pad at the end of the dispense cycle. (The actual amount left depends to some extent on the dissolution properties of the creamer powder. Typically, the rate of flow of water is such that the beverage is prepared in under one minute. It is known with some compositions to include filler agents. This may result in poorer dissolution of the composition and an increased amount remaining in the pad after use. In contrast, the dissolution properties can be improved by use of agents such as surfactants. However, use of such agents has been found to result in only limited reduction in the amount of the substance left in the pad after use). This disadvantage of this simple pad arrangement is that it can lead to a beverage or beverage portion being dispensed which is weaker than intended and also leads to wastage of the water soluble substance 14. Weak beverages can also be dispensed where the ingredients or part of the ingredients are by-passed by part of the water flow during dispensation.

Attempts have been made to overcome this problem by providing a form-retaining stiffening body within the interior of the storage volume 13. EP1398279 discloses use of a form-providing stiffening body comprising a grid structure that itself comprises a compartmenting wall configuration that spans between the upper and lower sheets of the flexible pad. Whilst the form-providing stiffening body prevents collapse of the pad and contact of the upper sheet and lower sheet of filter material, the structure described is complex and increases the cost and complexity of manufacture compared to the simpler pad as shown in FIGS. 1 and 2. In addition, the compartmenting wall configuration of the pad necessitates more careful filling of the storage volume with the water soluble substance to ensure consistent filling of the compartments.

Another disadvantage with the simple flexible pads of FIGS. 1 and 2 and the pad of EP1398279 is that, after use, the pad is left in a very wet state which is unpleasant for a user to handle when removing the pad manually from the beverage preparation machine. This can lead to dripping and soiling of the machine and surroundings as the pad is transported to a waste receptacle.

A further disadvantage of the known pads and the pads of EP1398279 is that, because substantial quantities of the water soluble substance can typically be left within the pad even at the end of a dispense cycle, the pad-holding section of the beverage preparation machine is left in a soiled state which is contaminated with beverage. As a result, the machine must be cleaned before a next beverage can be hygienically dispensed. The cleaning either involves manually disassembling the beverage preparation machine and washing the parts or by running another dispense cycle with no pad within the pad holding section so as to flush the beverage preparation machine. Both of these methods involves extra time and inconvenience to the user.

It is an object of the present invention to provide a pad which helps to alleviate these disadvantages.

Accordingly, the present invention provides a flexible pad for preparing a beverage comprising:

a filter bag defining a storage volume;

the storage volume containing a water-soluble composition or a combination or mixture of water-soluble compositions for forming a beverage;

wherein the storage volume further contains a plurality of non-soluble absorbent particles having a particle size, before use, of 25 microns to 10 mm.

The particle size required depends in part on the size of the pad. The particles are not necessarily spherical. Therefore the term particle size is to be understood as referring to the largest dimension of the particle.

The absorbent particles may be any suitable material which possesses water-retaining characteristics and preferably swells on contact with water. An advantage of the flexible pad of the present invention is that the absorbent particles may also be expandable so as to provide a structure which prevents collapse of the filter bag. The absorbent particles provide an inexpensive and straightforward mechanism for improving the dissolution of the water soluble substance contained in the storage volume of the flexible pad by ensuring that the pad does not collapse during the dispense cycle. The provision of absorbent particles in the storage volume does not greatly complicate the structure of the pad and leads to minimal additional complexity in the manufacturing process.

In one example the absorbent particles have a particle size of between 0.1 and 10 mm. This is particularly where the particle are formed from a spongiform material. The absorbent particles may have a particle size of about 3 mm.

In another example the absorbent particles have a particle size of between 25 to 100 microns. This is particularly where the particles are formed from an hydrogel.

Preferably, before exposure to liquid, the absorbent particles are compressed. By using a compressed form the dimensions and volume of the absorbent particles before dispensing may be minimised. This helps to reduce the overall size of the pads allowing for smaller packages of pads to be produced. Preferably, on exposure to liquid, the absorbent particles are expandable so as to have a size of between 500 microns and 50 mm. In one example, the absorbent particles are expandable so as to have a size of around 15 mm.

Preferably, the expansion in the absorbent particles is between 25 and 1000%, preferably 100 to 500%. The expansion may be omni-directional, bi-directional or uni-directional. In a preferred embodiment the particles each have a size (diameter or length) of 1 to 10 mm and a thickness of 1 to 3 mm before use. Preferably the ratio by weight of the powder to the absorbent particles before use is from 20:1 to 2:1, preferably around 3:1.

Advantageously during the dispense cycle as the absorbent particles are contacted by water they expand. The expansion may be as a result of the physical properties or chemical properties of the material of the absorbent particles or a combination of these factors.

In an alternative embodiment, before exposure to liquid, the absorbent particles each take the form of a porous mass. In this embodiment the absorbent particles are at all times in an expanded form.

The absorbent particles may be roughly spherical before and or after exposure to a liquid. Alternatively, the absorbent particles may be roughly block shaped before or after exposure to a liquid. Alternatively, the absorbent particles may be irregularly shaped before or after exposure to a liquid.

The absorbent particles may each have a smooth outer surface after exposure to a liquid. Alternatively, the absorbent particles may each have a convoluted outer surface after exposure to a liquid.

Preferably, the absorbent particles contact, in use, the filter bag. The physical contact between the absorbent particles and the filter bag acts to prevent collapse of the filter bag.

The filter bag may comprise an upper sheet and a lower sheet of filter material. The upper sheet and lower sheet may be initially separate and may then be sealed around a periphery to form the filter bag. Alternatively, the upper sheet and lower sheet may be formed from a single piece of filter material which is folded and sealed to form the filter bag. The absorbent particles help to prevent the upper sheet and lower sheet of the filtering material coming into contact with one another during use and as a result help to prevent the formation of low resistance short-circuits for water flow through the pad.

Advantageously, in use, the plurality of absorbent particles act as a support means for spacing apart an upper and a lower sheet of the filter bag. This prevents collapse of the filter bag both from the affects of the water flow through the pad and or the weight of any additional pad placed in use on the flexible pad as described above.

Advantageously, in use, the absorbent particles retain excess moisture. The water retaining properties of the absorbent particles help to retain the majority of any excess water that is left within the pad after the end of the dispense cycle. As a result the user may pick up the used pad and remove it to a waste receptacle with less soiling or dripping. In addition, the water absorbency of the absorbent particles means that less liquid is left in the pad holding section of the beverage preparation machine. As a consequence, cleaning of the machine is made easier.

The filter bag may be circular with a diameter of between 30 and 110 mm. Preferred diameters for the pad are between 60 and 70 mm, between 30 and 40 mm and between 100 and 110 mm. The diameter of the pad will depend on the nature of the beverage preparation machine for use with the pads. The filter bag may be other shapes, e.g. square, so as to fit a required beverage preparation machine.

In a preferred embodiment, the filter bag may have a diameter of substantially 69 mm.

Preferably the ratio by weight of the water soluble substance to the absorbent material before use is from 20:1 to 2:1.

In one example, the absorbent particles are spongiform. They may be formed from compressed sponge. Examples of suitable compressed sponge include the compressed cellulose sponge products F-11, F-12 and F-13 Wet Pack sponges manufactured by 3M. The compressed sponge exhibits good expansion behaviour in contact with water and has good water absorbency in the expanded state. For example, compressed sponge or natural sponge. Dried seaweed can form a suitable alternative material. The sponge is stable and is of food grade quality which is suitable for storing in contact with beverage ingredients.

As one alternative, the absorbent particles may be formed from a hydrogel, starch or a mixture of one or more of spongiform, starch and hydrogel materials. Suitable hydrogels include poly (HEMA) 2 hyroxyethyl methacrylate, polyacrylic, polyacyrylamide, Gelatine, Alginates, Agar and Carrageenan, and other hydrocolloids. Further, the absorbent particles may be formed from a foamed plastic.

The one or more absorbent particles may be separated from the water-soluble composition by means of a layer of filtering material which is non-transmissive to the water-soluble composition in dry form.

In one example, the one or more absorbent particles may interact with water in use such as to absorb water only during a portion of a dispense cycle.

Preferably, the one or more absorbent particles may interact with water at a predetermined temperature, pH or a start of a specified chemical reaction.

For example the one or more absorbent particles may comprise a soluble coating which, in use, is dissolvable in water to allow absorption of water to take place. For example, the soluble coating may comprise sugar or gelatine.

The water-soluble composition is preferably agglomerated. The agglomerated water-soluble composition may be produced by contacting the water-soluble composition with steam, water, or aqueous solution or dispersion to effect agglomeration, and optionally, either simultaneously or subsequently drying the agglomerated composition. In a comparison test, the amount of powder residue left in a standard pad was reduced from 50% to 35% when using an agglomerated powder rather than a non-agglomerated powder.

For the purposes of the present invention, water-soluble substances or compositions are defined as substances which wholly or substantially dissolve in the presence of a solvent which will typically be water. The ingredient composition of the substance before and after dissolution is substantially the same (excluding the diluting effect of the solvent). Thus, water-soluble substances exclude infusible substances such as roast and ground coffee and leaf tea. With infusible substances the ingredient composition of the infusion is substantially different to the ingredient composition of the infusible or extractable precursor since the infusion only contains certain flavour and/or aromatic qualities of the infusible substance. Examples of water-soluble substances according to the present invention include compositions such as milk powder, creamer powder, instant whitener, instant coffee, instant tea, instant soup, instant chocolate drink, sugar, instant fruit juice and instant dessert powders.

Preferably, the water-soluble composition is a milk powder or creamer powder. The milk powder or creamer powder may be a dairy or non-dairy spray-dried coffee creamer or coffee whitener. The fat component of the milk powder or creamer powder may have a melting point of 10 to 40 degrees Celsius.

The creamer powder may comprise one or more of vegetable fat, milk proteins, emulsifiers, stabilisers, foaming agents, milk fat, soy proteins, modified starches, carriers, fillers, sweeteners, flavours, colours, nutrients, preservatives and flow agents.

The present invention also provides a beverage brewing kit comprising a first flexible pad as described above in combination with a second flexible pad containing one or more beverage ingredients suitable for brewing. The second flexible pad may contain roast and ground coffee. The first and second pads may be joined prior to use or may be separate.

The present invention further provides a method of dispensing a beverage using a flexible pad as described above comprising the step of passing water downwardly through the flexible pad such that beverage initially exits the flexible pad through a lowermost surface thereof.

Alternatively water may pass upwardly through the flexible pad such that beverage initially exits the flexible pad through an uppermost surface thereof.

Alternatively the flexible pad may be orientated in a non-horizontal orientation, such as a vertical orientation, and water passed in a vertical or non-vertical direction through the flexible pad.

Flow of water through the pad may be substantially parallel to a major axis of the pad or substantially cross-ways to a major axis of the pad or in a direction part-way between parallel flow and cross flow.

Preferably water is passed through the flexible pad at a temperature greater than 70 degrees Celsius.

Optionally water is passed through the flexible pad as a discontinuous flow. Optionally, water is in the form of a pulsed flow.

A beverage is prepared using the pads of the present invention by inserting the pads in a beverage preparation machine. The pads may be used in a variety of beverage preparation machines. In one example, the beverage preparation machine generally comprises a housing containing a water heater, a water pump, optionally an air compressor, a control processor, a user interface and a head. The head in turn generally comprises a holder for holding, in use, the pad. The beverage preparation machine is also provided with a water tank.

The housing comprises a dispense station where dispensation of the beverage takes place. The dispense station comprises a receptacle stand having a hollow interior forming a drip tray.

The head is located towards the top of the housing above the receptacle stand. The holder of the head is shaped to receive the pad of the present invention and to hold the pad in the correct orientation such that water may be passed through the pad. Preferably the holder and head are provided with sealing means for sealing around a periphery of the pad to prevent by-pass flow of water in use. The head may be designed to direct flow of water downwardly through the pad so that beverage exits the pad through a lowermost surface of the pad. Alternatively, the head may be designed to direct flow of water upwardly through the pad so that beverage initially exits the pad through an uppermost surface of the pad before being ultimately directed downwardly to a receptacle. Of course the pad may be used in an orientation other than horizontal, for example, in a vertical orientation.

The user interface is located on the front of the housing and comprises a start/stop button, and a plurality of status indicators.

The start/stop button controls commencement of the operating cycle and is a manually operated push-button, switch or similar.

The water tank is located to the rear of the housing and is connected in use to a water tank station located at a rear half of the housing.

The water pump is operatively connected between the water tank and the water heater and is controlled by the control processor.

The water heater is located in the interior of the housing. The heater is able to heat water received from the water pump from a starting temperature of approximately 20° C. to an operating temperature of around 85° C. in under 1 minute.

The control processor of the beverage preparation machine comprises a processing module and a memory. The control processor is operatively connected to, and controls operation of, the water heater, water pump, air compressor and user interface.

The present invention also provides a water-soluble composition of a milk powder or creamer powder containing a plurality of dispersed non-soluble absorbent particles having a particle size of 25 microns to 10 mm.

Embodiments of the present invention will now be described, by way of example, with reference to the accompanying drawings in which:

FIG. 1 is an upper plan view of a prior art flexible pad;

FIG. 2 is a cross-sectional view of the flexible pad of FIG. 1;

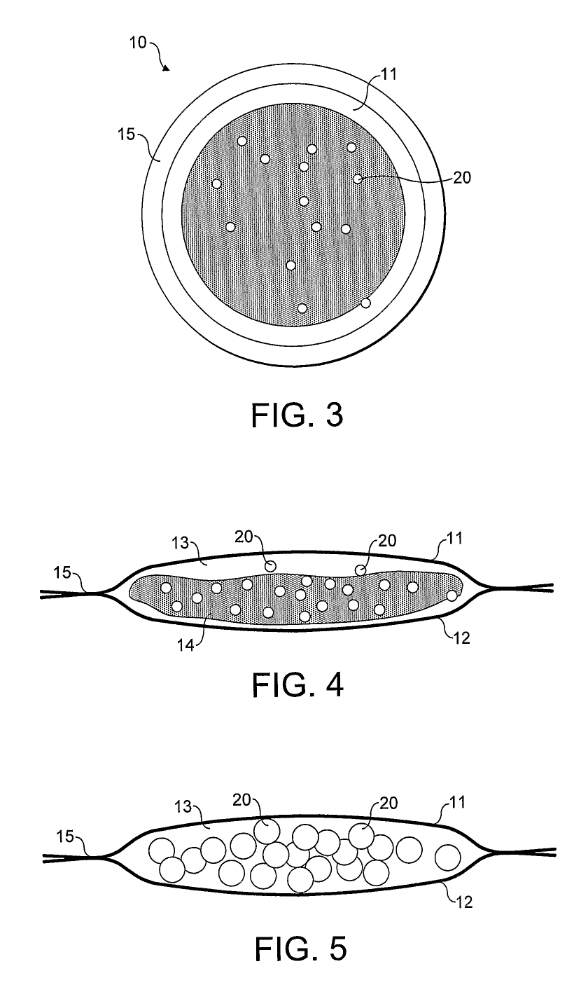

FIG. 3 is a top plan view of a flexible pad according to the present invention prior to use;

FIG. 4 is a cross-sectional view of the flexible pad of FIG. 3, again prior to use; and

FIG. 5 is a cross-sectional view of the flexible pad of FIG. 3 after use.

FIGS. 3 to 5 illustrate a flexible pad according to the present invention. As with the prior art pad of FIGS. 1 and 2, the pad 10 comprises an upper sheet 11 and lower sheet 12 of filter material which are joined by heat, adhesive or similar means around a periphery seam 15 to define a storage volume 13. The pad 10 has a diameter of between 30 and 110 mm. Preferred diameters for the pad are between 60 and 70 mm, between 30 and 40 mm and between 100 and 110 mm. The storage volume 13 contains a water soluble substance 14 which when dissolved in water will form a beverage or beverage portion. The invention finds particular application where the water soluble substance 14 is a milk powder or creamer powder. Milk powders include dried skimmed milk, part-skimmed milk, and whole milk, dried milk protein concentrates, isolates, and fractions, or any combination thereof. Creamer powders can be manufactured from dairy and/or non-dairy food ingredients and typically contain emulsified fat, stabilized by protein or modified starch, dispersed in a carrier that facilitates drying, especially spray drying. Optional ingredients include buffers, flavours, colours, fillers, sweeteners, foaming agents, flow agents, nutrients, preservatives, and the like. Milk powders and creamer powders are particularly useful as coffee whiteners for brewed, soluble, and flavoured coffee products, including latte and cappuccino. In the following description, for example only, the water soluble substance will be described as a creamer powder unless the context otherwise requires.

The creamer powder may for example comprise the following by weight:

| | |
|---|---|
| Hardened vegetable fat | 49% |
| Glucose syrup | 41% |
| Sodium Caseinate | 4.5% |
| Polyphosphates - K2HPO4 | 2.0% |
| Na-Polyphosphate | 2.5% |
| Silicon dioxide | 0.25% |
| Emulsifier (Sodium stearoyl-2-lactylate) | 0.75% |

Emulsifier (Sodium stearoyl-2-lactylate) 0.75%

Other compositions may be used which contain fillers such as lactose and additional stabilisers. Additional emulsifiers may be added to improve wetting. Advantageously, the creamer may be provided in an agglomerated form to assist and improve solubility. Advantageously, the creamer powder may comprise a low melting temperature fat having a melting temperature of between 10 and 40 degrees Celsius. Some or all of the fat content of the composition noted above may be substituted for low melting temperature fat. In one example the composition comprises 24% low melting temperature fat and 25% fat with a melting temperature of above 40 degrees Celsius. This results in a reduction of creamer powder residue in the pad of around 15 to 20%.

The storage volume 13 also contains a plurality of absorbent particles in the form of particles 20 of compressed sponge material. The particles 20 each a size (diameter or length) of 1 to 10 mm and a thickness of 1 to 3 mm before use. The particles 20 are formed from compressed cellulose sponge. Preferably the ratio by weight of the creamer powder to the absorbent particles before use is from 20:1 to 2:1, preferably around 3:1.

Prior to use of the flexible pad 10, the pad 10 and its contents are dry. If necessary, the pad 10 can be supplied in an hermetically sealed package to prevent moisture ingress or absorption.

As shown in FIG. 4, the compressed particles 20 are dispersed throughout the creamer powder 14 within the storage chamber 13.

In use, the flexible pad 10 is placed in a suitable beverage preparation machine and water is passed through the pad 10. Preferably the water is hot water where the water soluble substance is a creamer powder. The water is free to pass through and between the upper sheet 11 of the filter material and the lower sheet 12 of the filter material. On contact with the water, the compressed particles 20 rapidly expand. In the expanded state the particles 20 have a thickness of around 15 mm. The diameter of the particles 20 is not substantially changed, i.e. their expansion is uni-directional. Thus, the action of the liquid on the compressed sponge 20 is to produce an expansion in the compressed sponge 20 of around 500%. Alternatively, the particles 20 my expand bi-directionally or omni-directionally. Water is able to pass through the expanded sponge 20 substantially unhindered. As a result, the water quickly contacts and dissolves the creamer powder 14 to produce the milk based beverage or beverage portion. The beverage containing the dissolved creamer powder 14 passes through the lower filter sheet 18 and out of the beverage preparation machine.

In its expanded state shown in FIG. 5, the spongiform particles 20 act to maintain a separation of the upper sheet 11 of filter material and the lower sheet 12 of filter material by physically contacting both sheets. This advantageously helps to maintain the storage volume 13 as a single volume through which the water can easily circulate. In particular, the upper and lower sheets 11, 12 of the filter material are prevented from collapsing into contact with one another and thereby producing a low resistance flow path for water. In addition, the presence of the spongiform particles 20 is believed to improve the lateral spread of the water within the storage volume 13.

After use, the user of the beverage preparation machine removes the flexible pad 10 and disposes of it in a waste receptacle. Advantageously, the porous water-retaining nature of the spongiform particles 20 helps to retain excess moisture that may be within the pad 10. The capillary action of the pores of the spongiform particles 20 help to prevent dripping from the pad as it is transferred to a waste receptacle. In addition, the water-retaining nature of the spongiform particles has the consequence that the pad holding section of the beverage preparation machine contains less moisture and hence less contamination than compared with the use of prior art pads. As a result the machine is easier to clean and prepare in readiness for the next dispense cycle.

It has been found that the presence of the spongiform particles within the storage volume improves the dissolution of the creamer powder. Experiments were carried out using the pad of FIGS. 1 and 2 as a control. The experiments were carried out using a single serve brew machine that is suitable for use with such pads. It was found that with a standard creamer powder, 60% of the composition remained within the pad of FIGS. 1 and 2 after the dispense cycle. With the pad 10 of FIGS. 3 to 5 the amount of creamer residue remaining was reduced to 10% which was wetted but undissolved within the storage volume.

In another, non-illustrated, embodiment, the spongiform particles 20 are replaced by particles of a hydrogel substance in the form of spherical or otherwise shaped particles. In use, and on contact with water, the hydrogel absorbs water and expands. The expansion of the hydrogel particles aids dissolution of the creamer powder and also acts as a physical support for the filter bag. Advantageously, the intake of water by the hydrogel is rapid and results in the hydrogels absorbing preferentially water rather than dissolved creamer powder. As a result more creamer powder is dispensed. With such a pad the amount of creamer residue remaining within the storage volume 13 has been shown to be reduced to around 10%.

In a non-illustrated embodiment the absorbent particles are separated from the water-soluble composition by means of a layer of material, such as filter material. In this way the storage volume 13 can be divided either into horizontal layers or vertical compartments.

In the above the pad has been described as containing absorbent particles. The particles 20 may take various forms such as spheres, block shapes, tubes, rods, irregular shapes or be formed as shredded portions of a sheet material.

The flexible pad of the present invention may be provided with one or more structural supports in addition to the absorbent particles which span between opposed faces of the filter bag.

The water soluble substance has been described as preferably being a milk- or dairy-based creamer powder. However the pads of the present invention may also find application with other soluble ingredients such as instant coffee, instant tea, chocolate, soup or dessert ingredients.

The upper sheet 11 and lower sheet 12 have been described as being formed from filter material, such as that used commonly to form tea bags. However, other suitable materials may be used which are non-transmissive to the water soluble substance in the dry form but are transmissive to the water soluble substance when dissolved in water. For example, in an alternative embodiment the filter bag is formed from a spongiform material such as compressed sponge or expanded sponge. The sponge has a pore size that prevents transmission of the powdered form of the water-soluble composition but allows the dissolved composition to pass. In this embodiment the sponge filter bag may or may not include additional absorbent elements in the storage volume.

If preferred, the pad may be formed wholly of spongiform material of the types described above.

In the above description, the storage chamber 13 has been described as a unitary volume. However, the volume may be separated into multiple compartments using flexible materials. The chambers may if desired contain different beverage ingredients or the same ingredients. Some or all of the compartments may comprise absorbent bodies of the types described above. Some or all of the compartments may have dispersion discs contained therein.

The pad may be used for dispensing hot and cold beverages. Still and carbonated beverages may be produced by using still or carbonated water.

1. A flexible pad for preparing a beverage comprising:
a filter bag defining a storage volume;
the storage volume containing a water-soluble composition or a combination or mixture of water-soluble compositions for forming a beverage;
wherein the storage volume further contains a plurality of non-soluble absorbent particles having a particle size, before use, of 25 microns to 10 mm.

2. A flexible pad as claimed in claim 1 wherein the absorbent particles have a particle size of between 0.1 and 10 mm.

3. A flexible pad as claimed in claim 2 wherein the absorbent particles have a particle size of about 3 mm.

4. A flexible pad as claimed in claim 1 wherein the absorbent particles have a particle size of between 25 to 100 microns.

5. A flexible pad as claimed in claim 1 wherein, before exposure to liquid, the absorbent particles are compressed.

6. A flexible pad as claimed in claim 5 wherein, on exposure to liquid, the absorbent particles are expandable so as to have a size of between 500 microns and 50 mm.

7. A flexible pad as claimed in claim 6 wherein the absorbent particles are expandable so as to have a size of around 15 mm.

8. A flexible pad as claimed in claim 6 wherein the expansion in the absorbent particles is between 25 and 1000%.

9. A flexible pad as claimed in claim 8 wherein the expansion in the absorbent particles is around 100 to 500%.

10. A flexible pad as claimed in claim 1 wherein, before exposure to liquid, the absorbent particles each take the form of a porous mass.

11. A flexible pad as claimed in claim 1 wherein the absorbent particles are roughly spherical before or after exposure to a liquid.

12. A flexible pad as claimed in claim 1 wherein the absorbent particles are roughly block shaped before or after exposure to a liquid.

13. A flexible pad as claimed in claim 1 wherein the absorbent particles are irregularly shaped before or after exposure to a liquid.

14. A flexible pad as claimed in claim 1 wherein the absorbent particles each have a smooth outer surface after exposure to a liquid.

15. A flexible pad as claimed in claim 1 wherein the absorbent particles each have a convoluted outer surface after exposure to a liquid.

16. A flexible pad as claimed in claim 1 wherein the absorbent particles contact, in use, the filter bag.

17. A flexible pad as claimed in claim 1 wherein the filter bag comprises an upper sheet and a lower sheet of filter material.

18. A flexible pad as claimed in claim 17 wherein the upper sheet and lower sheet are initially separate and are then sealed around a periphery to form the filter bag.

19. A flexible pad as claimed in claim 17 wherein the upper sheet and lower sheet are formed from a single piece of filter material which is folded and sealed to form the filter bag.

20. A flexible pad as claimed in claim 17 wherein, in use, the absorbent particles act as a support means for spacing apart the upper and the lower sheet of the filter bag.

21. A flexible pad as claimed in claim 17 wherein the filter bag is circular with a diameter of 30 to 110 mm.

22. A flexible pad as claimed in claim 21 wherein the filter bag has a diameter of substantially 69 mm.

23. A flexible pad as claimed in claim 20 wherein, in use, the absorbent particles are spongiform.

24. A flexible pad as claimed in claim 23 wherein the absorbent spongiform particles are formed from compressed cellulose sponge or foamed plastic.

25. A flexible pad as claimed in claim 20 wherein the absorbent particles are formed from hydrogel, starch or a mixture of one or more of spongiform, starch and hydrogel materials.

26. A flexible pad as claimed in claim 1 wherein the one or more absorbent particles are separated from the water-soluble composition by means of a layer of filtering material which is non-transmissive to the water-soluble composition in dry form.

27. A flexible pad as claimed in claim 26 wherein the one or more absorbent particles interact with water in use such as to absorb water only during a portion of a dispense cycle.

28. A flexible pad as claimed in claim 27 wherein the one or more absorbent particles interact with water at a predetermined temperature, pH or a start of a specified chemical reaction.

29. A flexible pad as claimed in claim 27 wherein the one or more absorbent particles comprise a soluble coating which, in use, is dissolvable in water to allow absorption of water to take place.

30. A flexible pad as claimed in claim 29 wherein the soluble coating comprises sugar or gelatine.

31. A flexible pad as claimed in claim 26 wherein the water-soluble composition is agglomerated.

32. A flexible pad as claimed in claim 31 wherein the agglomerated water-soluble composition is produced by contacting the water-soluble composition with steam, water, or aqueous solution or dispersion to effect agglomeration, and optionally, either simultaneously or subsequently drying the agglomerated composition.

33. A flexible pad as claimed in claim 32 wherein the water-soluble composition is a milk powder or creamer powder.

34. A flexible pad as claimed in claim 33 wherein the milk powder or creamer powder is a dairy or non-dairy spray-dried coffee creamer or coffee whitener.

35. A flexible pad as claimed in claim 33 wherein a fat component of the milk powder or creamer powder has a melting point of 10 to 40 degrees Celsius.

36. A flexible pad as claimed in claim 34 wherein the creamer powder comprises one or more of vegetable fat, milk proteins, emulsifiers, stabilisers, foaming agents, milk fat, soy proteins, modified starches, carriers, fillers, sweeteners, flavours, colours, nutrients, preservatives and flow agents.

37. A beverage brewing kit comprising a first flexible pad as claimed in claim 1 in combination with a second flexible pad containing one or more beverage ingredients suitable for brewing.

38. A beverage brewing kit as claimed in claim 37 wherein the second flexible pad contains roast and ground coffee.

39. A beverage brewing kit as claimed in claim 37 wherein the first and second pads are joined prior to use.

40. A water-soluble composition of a milk powder or creamer powder containing a plurality of dispersed non-soluble absorbent particles having a particle size of 25 microns to 10 mm.

41. A method of dispensing a beverage using a flexible pad as claimed in claim 1 comprising the step of passing water downwardly through the flexible pad such that beverage initially exits the flexible pad through a lowermost surface thereof.

42. A method of dispensing a beverage using a flexible pad as claimed in claim 1 comprising the step of passing water upwardly through the flexible pad such that beverage initially exits the flexible pad through an uppermost surface thereof.

43. A method of dispensing a beverage using a flexible pad as claimed in claim 1 comprising the step of orientating the flexible pad in a non-horizontal orientation and passing water in a vertical or non-vertical direction through the flexible pad.

44. A method of dispensing a beverage using a flexible pad as claimed in claim 1 wherein flow of water through the pad may be substantially parallel to a major axis of the pad or substantially cross-ways to a major axis of the pad or in a direction part-way between parallel flow and cross flow.

45. A method of dispensing a beverage using a flexible pad as claimed in claim 1 comprising the step of passing water through the flexible pad at a temperature greater than 70 degrees Celsius.

46. A method of dispensing a beverage using a flexible pad as claimed in claim 1 comprising the step of passing water through the flexible pad as a discontinuous flow.

47. A method of dispensing a beverage as claimed in claim 46 wherein the discontinuous flow of water is a pulsed flow.
